(19) United States
(12) Patent Application Publication
(10) Pub. No.: US 2026/0254700 A1
(43) Pub. Date: Aug. 27, 2026

(54) SYNCHRONIZING CARRIER FREQUENCY OF MULTIPLE ACCESS POINTS

(71) Applicant: Samsung Electronics Co., Ltd., Suwon-si (KR)

(72) Inventors: Bilal Sadiq, Plano, TX (US); Vishnu Vardhan Ratnam, Frisco, TX (US); Yue Qi, Plano, TX (US); Peshal Nayak, Plano, TX (US); Rubayet Shafin, Frisco, TX (US); Boon Loong Ng, Plano, TX (US)

(21) Appl. No.: 19/543,709

(22) Filed: Feb. 18, 2026

Related U.S. Application Data
(60) Provisional application No. 63/764,358, filed on Feb. 27, 2025.
(60) Provisional application No. 63/783,589, filed on Apr. 4, 2025.

(51) Int. Cl. H04L 27/26; H04L 5/00; H04W 88/08

(52) U.S. Cl. CPC H04L 27/2657; H04L 5/005; H04W 88/08

(57) ABSTRACT

Methods and systems for synchronizing carrier frequency of multiple access points. A method includes receiving a first frame from a second AP device. The method also includes estimating a frequency pre-correction value based on the received signal of the first frame. The method also includes adjusting a frequency for a second frame to be transmitted following reception of the first frame based on the frequency pre-correction value. The method also includes transmitting the second frame based on the adjusted frequency.

### CROSS-REFERENCE TO RELATED APPLICATIONS AND CLAIM OF PRIORITY

The present application claims priority to U.S. Provisional Patent Application No. 63/764,358, filed on Feb. 27, 2025 and to U.S. Provisional Patent Application No. 63/783,589, filed on Apr. 4, 2025. The contents of the above-identified patent documents are incorporated herein by reference.

### TECHNICAL FIELD

The present disclosure relates generally to wireless communication systems. more specifically, the present disclosure relates to systems and methods for synchronizing carrier frequency of multiple access points.

### BACKGROUND

The carrier frequency of two devices may be considered synchronized when the carrier frequency offset (CFO), or the difference between the carrier frequencies of the devices, is nearly zero or smaller than an acceptable threshold. Carrier synchronization between two or more access points (APs) may be required for accurate channel sounding, for example, sounding the channel between a station (STA) and each AP. Carrier synchronization may also be required for various coordination schemes, including coordinated beamforming (CoBF), among the APs. Carrier synchronization between the coordinating APs may be required for channel sounding as well as for coordinated data communication.

### SUMMARY

The present disclosure relates generally to wireless communication systems and, more specifically, the present disclosure relates to systems and methods for synchronizing carrier frequency of multiple access points.

In one embodiment, a method performed by an access point (AP) device is provided. The method includes receiving a first frame from a second AP device. The method also includes estimating a frequency pre-correction value based on the received signal of the first frame. The method also includes adjusting a frequency for a second frame to be transmitted following reception of the first frame based on the frequency pre-correction value. The method also includes transmitting the second frame based on the adjusted frequency.

In another embodiment, a method performed by a second access point (AP) in response to a first AP device. The method includes transmitting a first frame to the first AP device. The method also includes receiving a second frame with a first adjusted frequency. The method also includes estimating a frequency pre-correction value based on the received signal of the second frame. The method also includes adjusting a second frequency for a third frame to be transmitted following reception of the second frame based on the frequency pre-correction value. The method also includes transmitting the third frame based on the adjusted second frequency.

In yet another embodiment, an electronic device is provided. The electronic device includes at least one processor including processing circuitry and a memory storing instructions. The instructions, when executed by the at least one processor individually or collectively, cause the electronic device to receive a first frame from a second AP device. The instructions, when executed by the at least one processor individually or collectively, also cause the electronic device to estimate a frequency pre-correction value based on the received signal of the first frame. The instructions, when executed by the at least one processor individually or collectively, also cause the electronic device to adjust a frequency for a second frame to be transmitted following reception of the first frame based on the frequency pre-correction value. The instructions, when executed by the at least one processor individually or collectively, also cause the electronic device to transmit the second frame based on the adjusted frequency.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example AP device according to embodiments of the present disclosure;

FIG. 2B illustrates an example STA according to embodiments of the present disclosure;

FIG. 3 illustrates an example joint sounding transmission diagram supporting synchronization of carrier frequency of multiple access points according to embodiments of the present disclosure;

FIG. 4 illustrates an example sequential sounding transmission diagram supporting synchronization of carrier frequency of multiple access points according to embodiments of the present disclosure;

FIG. 5 illustrates an example cross-basic service set (BSS) sounding transmission diagram supporting synchronization of carrier frequency of multiple access points according to embodiments of the present disclosure;

FIG. 6 illustrates an example cross-BSS sounding transmission diagram supporting synchronization of carrier frequency of multiple access points according to embodiments of the present disclosure;

FIG. 7 illustrates an example flow chart of a method for synchronizing carrier frequency of multiple access points according to embodiments of the present disclosure; and

FIG. 8 illustrates an example flow chart of a method for synchronizing carrier frequency of multiple access points according to embodiments of the present disclosure.

### DETAILED DESCRIPTION

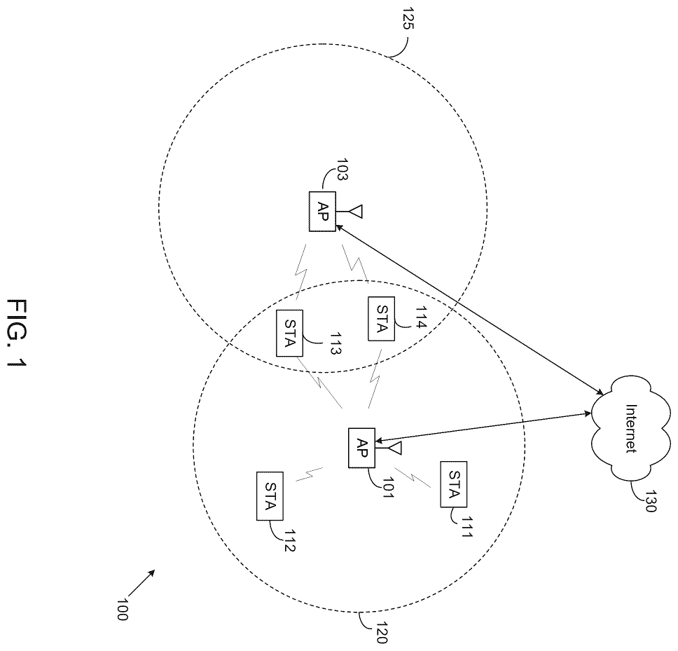

FIG. 1 through FIG. 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As introduced above, the carrier frequency of two devices may be considered synchronized when the carrier frequency offset (CFO), or the difference between the carrier frequencies of the devices, is nearly zero or smaller than an acceptable threshold. Carrier synchronization between two or more access points may be required for accurate channel sounding, for example, sounding the channel between a station (STA) and each AP. Carrier synchronization may also be required for various coordination schemes among the APs. Multiple APs, for example, neighboring APs operating on at least one common channel, may coordinate among themselves to improve system performance, including data rate, reliability, and latency. For example, two or more APs may perform coordinated beamforming (CoBF) or make precoding decisions for simultaneous transmissions, such that each AP may serve a respective associated STA while causing a lower impact, for example, reduced interference, to the STA that another AP is serving simultaneously. Carrier synchronization between the coordinating APs may be required for channel sounding as well as for coordinated data communication.

However, for coordinated channel sounding and data transmission to function effectively, the carrier frequencies of the two APs should be synchronized or matched for various joint transmissions. Additionally, the carrier frequency across various sounding phases should remain consistent.

Accordingly, the present disclosure provides systems and methods for synchronizing carrier frequency of multiple access points. As described herein, the present disclosure includes systems and methods that include estimating a frequency pre-correction value based on a received signal of a first frame then adjusting a frequency for a second frame to be transmitted following reception of the first frame based on the frequency pre-correction value. The present disclosure, thus, applies a frequency pre-correction value to frames to-be transmitted that adjust carrier synchronization between the coordinating APs.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes AP devices 101 and 103. The AP devices 101 and 103 communicate with at least one network 130, such as the Internet, a proprietary Internet Protocol (IP) network, or other data network. The AP device 101 provides wireless access to the network 130 for a plurality of STAs 111-114 within a coverage area 120 of the AP device 101. The AP devices 101-103 may communicate with each other and with the STAs 111-114 using Wi-Fi or other WLAN communication techniques.

Depending on the network type, other well-known terms may be used instead of “access point” or “AP device,” such as “router” or “gateway.” For the sake of convenience, the term “AP device” is used in this disclosure to refer to network infrastructure components that provide wireless access to remote terminals. In WLAN, given that the AP device also contends for the wireless channel, the AP device may also be referred to as a STA (e.g., an AP device STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP device or contends for a wireless channel in a WLAN, whether the STA is a mobile device (such as a mobile telephone or smartphone) or is normally considered a stationary device (such as a desktop computer, AP device, media player, stationary sensor, television, etc.). This type of STA may also be referred to as a non-AP device STA.

In various embodiments of this disclosure, each of the AP devices 101 and 103 and each of the STAs 111-114 may be an MLD. In such embodiments, AP devices 101 and 103 may be AP device MLDs, and STAs 111-114 may be non-AP device MLDs. Each MLD is affiliated with more than one STA. For convenience of explanation, an AP device MLD is described herein as affiliated with more than one AP device (e.g., more than one AP device STA), and a non-AP device MLD is described herein as affiliated with more than one STA (e.g., more than one non-AP device STA).

Dotted lines show the approximate extents of the coverage areas 120 and 125, which are shown as approximately circular for the purposes of illustration and explanation only. It should be clearly understood that the coverage areas associated with AP devices, such as the coverage areas 120 and 125, may have other shapes, including irregular shapes, depending upon the configuration of the AP devices and variations in the radio environment associated with natural and man-made obstructions.

As described in more detail below, one or more of the AP devices may include circuitry and/or programming for facilitating configuring a transmission for reception at an associated STA and an unassociated STA. Although FIG. 1 illustrates one example of a wireless network 100, various changes may be made to FIG. 1. For example, the wireless network 100 could include any number of AP devices and any number of STAs in any suitable arrangement. Also, the AP device 101 could communicate directly with any number of STAs and provide those STAs with wireless broadband access to the network 130. Similarly, each AP device 101-103 could communicate directly with the network 130 and provide STAs with direct wireless broadband access to the network 130. Further, the AP devices 101 and/or 103 could provide access to other or additional external networks, such as external telephone networks or other types of data networks.

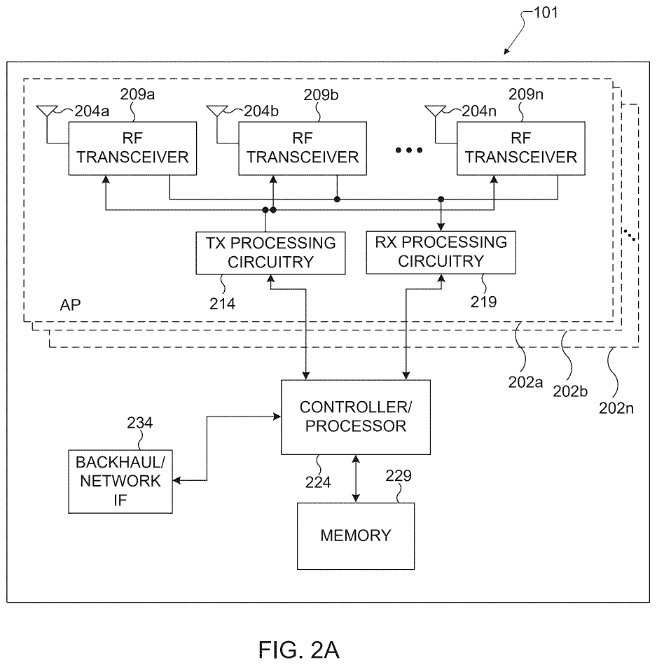

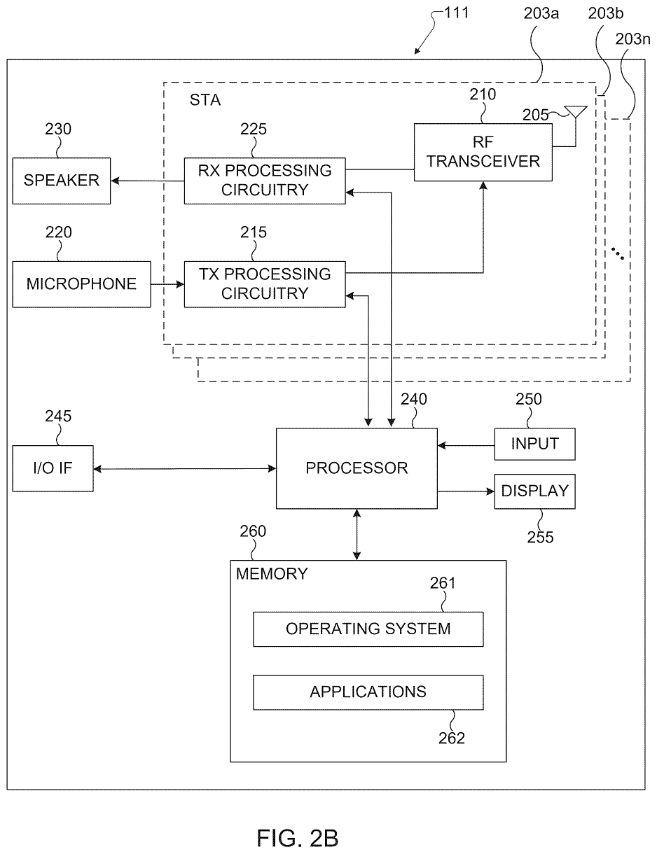

FIG. 2A illustrates an example AP device 101 according to various embodiments of the present disclosure. The embodiment of the AP device 101 illustrated in FIG. 2A is for illustration only, and the AP device 103 of FIG. 1 could have the same or similar configuration. In the embodiments discussed herein below, the AP device 101 is an AP device MLD. However, AP devices come in a wide variety of configurations, and FIG. 2A does not limit the scope of this disclosure to any particular implementation of an AP device.

The AP device MLD 101 is affiliated with multiple AP devices 202a-202n (which may be referred to, for example, as AP1-APn). Each of the affiliated AP devices 202a-202n includes multiple antennas 204a-204n, multiple RF transceivers 209a-209n, transmit (TX) processing circuitry 214, and receive (RX) processing circuitry 219. The AP device MLD 101 also includes a controller/processor 224, a memory 229, and a backhaul or network interface 234.

The illustrated components of each affiliated AP device 202a-202n may represent a physical (PHY) layer and a lower media access control (LMAC) layer in the open systems interconnection (OSI) networking model. In such embodiments, the illustrated components of the AP device MLD 101 represent a single upper MAC (UMAC) layer and other higher layers in the OSI model, which are shared by all of the affiliated AP devices 202a-202n.

For each affiliated AP device 202a-202n, the RF transceivers 209a-209n receive, from the antennas 204a-204n, incoming RF signals, such as signals transmitted by STAs in the network 100. In some embodiments, each affiliated AP device 202a-202n operates at a different bandwidth, e.g., 2.4 GHz, 5 GHz, or 6 GHz, and accordingly the incoming RF signals received by each affiliated AP device may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP device 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP device 202a-202n operates at a different bandwidth, e.g., 2.4 GHz, 5 GHz, or 6 GHz, the outgoing RF signals transmitted by each affiliated AP device may be at a different frequency of RF.

The controller/processor 224 can include one or more processors or other processing devices that control the overall operation of the AP device MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP device MLD 101 by the controller/processor 224 including facilitating transmission for reception at an associated AP and an unassociated AP. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP device MLD 101 to communicate with other devices or systems over a backhaul connection or over a network. The interface 234 could support communications over any suitable wired or wireless connection(s). For example, the interface 234 could allow the AP device MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP device MLD 101 may include circuitry and/or programming for configuring a transmission for reception at an associated STA and an unassociated STA. Although FIG. 2A illustrates one example of AP device MLD 101, various changes may be made to FIG. 2A. For example, the AP device MLD 101 could include any number of each component shown in FIG. 2A. As a particular example, an AP device MLD 101 could include a number of interfaces 234, and the controller/processor 224 could support routing functions to route data between different network addresses. As another particular example, while each affiliated AP device 202a-202n is shown as including a single instance of TX processing circuitry 214 and a single instance of RX processing circuitry 219, the AP device MLD 101 could include multiple instances of each (such as one per RF transceiver) in one or more of the affiliated AP devices 202a-202n. Alternatively, only one antenna and RF transceiver path may be included in one or more of the affiliated AP devices 202a-202n, such as in legacy AP devices. Also, various components in FIG. 2A could be combined, further subdivided, or omitted and additional components could be added according to particular needs.

FIG. 2B illustrates an example non-AP device MLD 111 according to various embodiments of this disclosure. The embodiment of the non-AP device MLD 111 illustrated in FIG. 2B is for illustration only, and the STAs 111-115 of FIG. 1 could have the same or similar configuration. In the embodiments discussed herein below, the STA 111 is a non-AP device MLD. However, STAs come in a wide variety of configurations, and FIG. 2B does not limit the scope of this disclosure to any particular implementation of a STA.

The non-AP device MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP device MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP device MLD 111 represent a single UMAC layer and other higher layers in the OSI model, which are shared by all of the affiliated STAs 203a-203n.

For each affiliated STA 203a-203n, the RF transceiver 210 receives, from the antenna(s) 205, an incoming RF signal transmitted by an AP device of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The processor 240 can include one or more processors and execute the basic OS program 261 stored in the memory 260 in order to control the overall operation of the non-AP device MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to facilitate configuring a transmission for reception at an associated AP device and an unassociated AP device. In some embodiments, the controller/processor 240 includes at least one microprocessor or microcontroller.

The processor 240 is also capable of executing other processes and programs resident in the memory 260, such as operations for facilitating transmission for reception at an associated AP and an unassociated AP. The controller/processor 240 can move data into or out of the memory 260 as required by an executing process. In some embodiments, the controller/processor 240 is configured to execute a plurality of applications 262, such as applications for facilitating transmission for reception at an associated AP and an unassociated AP. The controller/processor 240 can operate the plurality of applications 262 based on the OS program 261 or in response to a signal received from an AP device. The main controller/processor 240 is also coupled to the I/O interface 245, which provides non-AP device MLD 111 with the ability to connect to other devices such as laptop computers and handheld computers. The I/O interface 245 is the communication path between these accessories and the main controller 240.

The processor 240 is also coupled to the touchscreen 250 and the display 255. The operator of the non-AP device MLD 111 can use the touchscreen 250 to enter data into the non-AP device MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP device MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP device 101. In another example, the non-AP device MLD 111 may not include voice communication or the controller/processor 240 could be divided into multiple processors, such as one or more central processing units (CPUs) and one or more graphics processing units (GPUs). Also, while FIG. 2B illustrates the non-AP device MLD 111 configured as a mobile telephone or smartphone, non-AP device MLDs can be configured to operate as other types of mobile or stationary devices.

This disclosure presents techniques to synchronize the carrier frequency of two or more wireless devices, such as APs. The carrier frequency of two devices may be considered synchronized if the carrier frequency offset (CFO), or difference between the carrier frequencies of the devices, is nearly zero or smaller than an acceptable threshold, for example 350 Hz at the 90th percentile. Carrier synchronization between two or more APs may be required for accurate channel sounding, for example when sounding the channel between a station (STA) and each AP. Carrier synchronization may also be required for various coordination schemes among APs. Multiple APs, for example neighboring APs operating on at least one common channel, may coordinate amongst themselves to improve system performance, such as data rate, reliability, and latency. As an example, two or more APs may perform coordinated beamforming (CoBF) or precoding decisions for simultaneous transmissions, such that each AP may serve a respective associated STA while causing a lower impact, such as interference, to the STA that the other AP is serving simultaneously. Carrier synchronization between the coordinating APs may be required for channel sounding as well as for coordinated data communication.

In the case of two coordinating AP devices, each AP device may have one or more STAs associated with the AP device. The AP devices may exchange frames with each other to arrange to set up and obtain Channel State Information (CSI), such as a beamforming report, indication of the channel matrix, or a partial list of right singular vectors and associated singular values of the channel matrix, from the one or more STAs. For example, one AP device may transmit a Null Data Packet Announcement (NDPA) containing an inter-AP device field for the other AP device, asking the other AP device to send a Null Data Packet (NDP), and simultaneously asking an associated STA to perform channel measurement on the NDP. AP devices may also exchange frames with each other to arrange or trigger coordinated data transmissions to or from the one or more STAs. These frame exchanges between the coordinating AP devices can be used by the receiving AP device to estimate CFO with respect to the transmitting AP device. An AP device that has a valid (for example, sufficiently recent) estimate of CFO with respect to the other AP device can then synchronize the carrier frequency of that AP device to the other AP device for subsequent transmission, when needed. For example, an AP device can synchronize the carrier for a transmission where both AP devices jointly transmit an NDP to a STA to sound the channels between the STA and each AP device.

For coordinated channel sounding and data transmission to work well, the carrier frequency of the two AP devices should be synchronized or matched for various joint transmissions. Moreover, the carrier frequency across various sounding phases should remain the same. For example, if a first phase of channel sounding is performed with second AP device synchronizing with first AP device while a second phase of channel sounding is performed with first AP device synchronizing with second AP device, this approach may not work well in general because the carrier frequency of first AP device may have a large offset with respect to second AP device. That is, while there is no inter-AP device CFO in each sounding phase, there may be carrier frequency difference across the sounding phases. However, if after the first phase of sounding (where second AP device synchronizes with first AP device) second AP device continues to compensate the carrier frequency of second AP device at least for subsequent phases of sounding with first AP device, then the above scheme may work well. As the carrier of second AP device is synchronized with first AP device, first AP device in turn synchronizing the carrier of first AP device with second AP device for the second phase will still ensure that carrier frequency across the sounding phases remains the same. After the first sounding phase (where second AP device synchronizes with first AP device), second AP device is not required to permanently keep the carrier of second AP device synchronized with first AP device. Rather, second AP device is merely required to synchronize the carrier of second AP device to first AP device for the subsequent channel sounding and data transmission phases that are associated with the first channel sounding. This approach allows second AP device to continue coordinating with multiple different AP devices and synchronizing the carrier of second AP device with those AP devices as needed.

The inter-AP device carrier synchronization requirements may therefore be stated as follows. The carrier frequency difference between the transmission of first AP device and that of second AP device should be smaller than an acceptable threshold, for example 350 Hz for the 90th percentile. Additionally, carrier frequency during all sounding transmissions and subsequent PPDU or data transmission of an AP device should be fairly close, for example much smaller than the OFDM subcarrier spacing.

In some cases, when an AP device is exclusively sounding one or more associated STAs (meaning the NDP for sounding is being transmitted by the AP device alone), the AP device could either transmit the NDP with a carrier synchronized with the other AP device as stated above, or the AP device could transmit the NDP with an unsynchronized carrier and subsequently compensate the CSI reported by the STAs for the inter-AP device CFO.

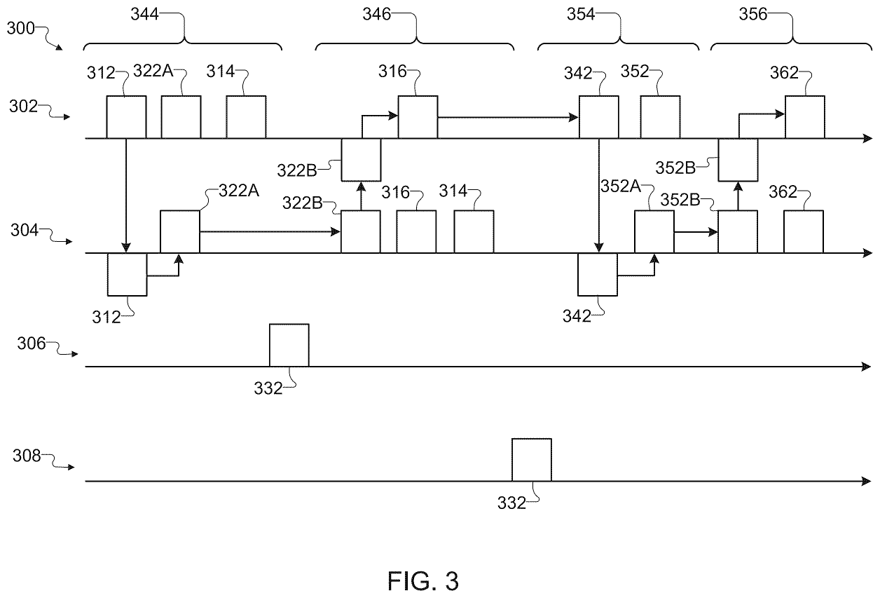

FIG. 3 illustrates an example joint sounding transmission diagram 300 supporting synchronization of carrier frequency of multiple access points according to embodiments of the present disclosure. For ease of explanation, the joint sounding transmission diagram 300 will be described as including one or more components of the wireless network 100 of FIG. 1, such as the APs 101, 103 and the STAs 111-114; however, the joint sounding transmission diagram 300 could be implemented using any other suitable device or system. The embodiment of the joint sounding transmission diagram 300 shown in FIG. 3 is for illustration only. Other embodiments of the joint sounding transmission diagram 300 could be used without departing from the scope of this disclosure.

As shown in FIG. 3, the joint sounding transmission diagram 300 includes a frame exchange between a first AP device 302, a second AP device 304, a first non-AP STA 306, and a second non-AP STA 308 during a joint sounding operation. The first AP device 302 may be set as a reference AP, such as a sync reference AP. In this configuration, the first AP device 302 may transmit a first frame 312 to the second AP device 304 during a first sounding phase 344. The second AP device 304 receives the first frame 312 and determines a pre-correction value (such as a carrier frequency offset (CFO) correction value), based on the received signal from the first frame 312. For example, the pre-correction value may be determined by the following:

$${f}_{AP 2} ( new ) = {f}_{AP 2} ( old ) + Δ {f}_{21}$$

where, f_{Ap2}(new) is an updated frequency value of the second AP device 304, f_{AP2}(old) is an original or previous frequency value of the second AP device 304, and f₂₁ is the pre-correction value.

The second AP device 304 uses the pre-correction value to compensate the carrier of the second AP device 304 for subsequent transmissions, such as for second frames 322A and 322B. The second AP device 304 transmits the second frame 322A immediately in response to the first frame 312. The frame 322A may be a sounding frame. The second AP device 304 transmits the second frame 322B later in time to the first AP device 302. The frame 322B may be a sounding announcement frame to start a second sounding phase 346 described later. The first AP device 302 may subsequently transmit a trigger frame 314, such as a beamforming report poll (BFRP) trigger frame. The first non-AP STA 306 may also transmit channel state information (CSI) as needed, such as the CSI frames 332. It should be noted that while various transmissions such as 322A and 316 are being referred to as a frame, they may not necessarily contain a MAC frame and may comprise a PPDU transmission such as an NDP PPDU that does not include a MAC frame.

The first AP device 302 and the second AP device 304 may undergo a second sounding phase 346, where the first AP device 302 and the second AP device 304 switch operational roles (such as the first AP device 302 treating the second AP device 304 as the sync reference). In such situations, the first AP device 302 may apply a second pre-correction value to compensate the carrier of the first AP device 302 for subsequent transmissions, such as for a third frame 316. The first AP device 302 may determine the second pre-correction value based on received signal from the frame 322B from the second AP device 304. Similarly, the second pre-correction value may may be determined by the following:

$${f}_{AP 1} ( new ) = {f}_{AP 1} ( old ) + Δ {f}_{12}$$

where, f_{AP1} (new) is an updated frequency value of the second AP device 304, f_{AP1} (old) is an original or previous frequency value of the second AP device 304, and f₁₂ is the pre-correction value.

After the sounding phases (such as the first sounding phase 344 and the second sounding phase 346), the first AP device 302, the second AP device 304, the first non-AP STA 306, and the second non-AP STA 308 may perform transmission phases, such as during a first coordinated data transmission phase 354. For example, the first AP device 302 may transmit a first transmission frame 342 to the second AP device 304. The second AP device 304 may estimate a pre-correction value based on the first transmission frame 342 and applies the pre-correction value to a second transmission frame 352A and 352B. The frame 352A transmitted by the second AP device 304 is a data transmission to its associated non-AP STA 308, whereas the frame 352 transmitted by the first AP device 302 is a data transmission to its associated non-AP STA 306. The frame 352B transmitted by the second AP device 304 to the first AP device 302 starts a data transmission phase 356 described next. The first AP device 302, the second AP device 304, the first non-AP STA 306, and the second non-AP STA 308 may undergo subsequent transmission phases, such as a second coordinated data transmission phase 356 that use the second transmission frame 352B from the second AP device 304 to update a third transmission frame 362 from the first AP device 302.

FIG. 3 illustrates how carrier synchronization is achieved and maintained through examples of Coordinated Beamforming (CoBF) operation. In steady state, the estimated carrier frequency offsets (CFOs) at either AP device converge to or hover around zero. More precisely, the estimated CFO at each AP device 302, 304 represents only the residual offset. The following discussion further describes the procedure followed by each AP device 302, 304 to achieve and maintain carrier synchronization.

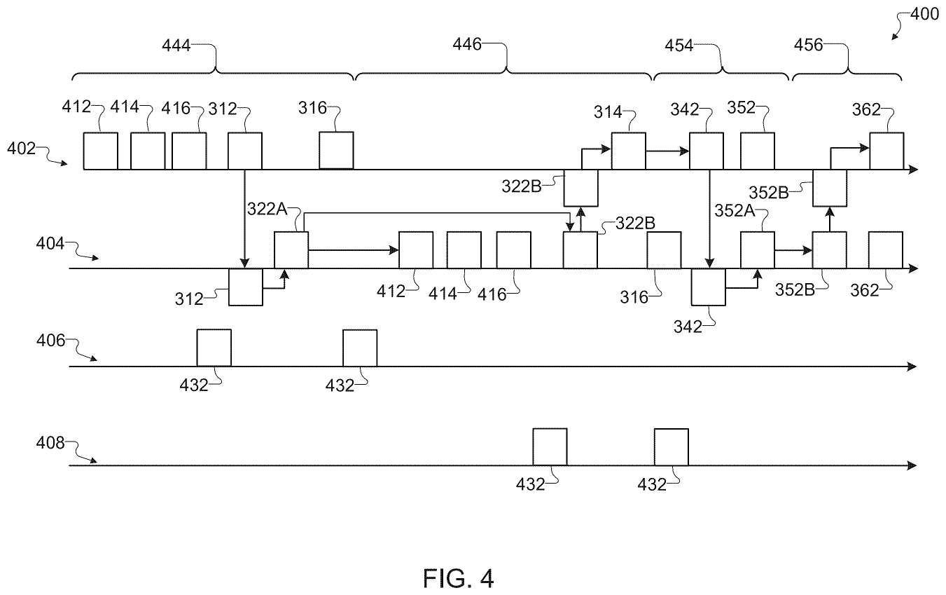

An AP device receiving a Null Data Packet Announcement (NDPA), CoBF-trigger (alternatively called CoBF SYNC), or other frames containing inter-AP device fields (such as the second AP device 304) from another AP device (such as the first AP device 302) as part of coordinated operation shall apply sync follower behavior. Under this behavior, the second AP device 304 estimates the residual pre-corrected value with respect to the first AP device 302. Furthermore, if a valid pre-corrected value estimate is available, the second AP device 304 removes pre-corrected value from subsequent transmissions that are required to be carrier synchronized for coordinated operation. Coordinated-operation-related transmissions that may require carrier synchronization include NDPA and Null Data Packet (NDP) for joint sounding, NDPA and NDP for sequential sounding (shown in FIG. 4), CoBF trigger frames, and CoBF Protocol Data Units (PPDUs). For NDPA and NDP transmission during sequential in-BSS sounding, the second AP device 304 either removes the estimated pre-corrected value from the NDPA and NDP transmission or post-corrects channel feedback according to the estimated pre-corrected value.

Regarding the validity duration of inter-AP device pre-corrected value estimates for coordinated operation, an AP device is allowed to forget inter-AP device residual pre-corrected value correction if the correction has not been refreshed or used for transmission for a specified number of seconds. An AP device (such as the first AP device 302, the second AP device 304, or both) deems an estimated inter-AP device pre-corrected value as valid for compensating an upcoming coordinated-operation-related transmission under two conditions. First, the pre-corrected value was estimated from a transmission that started less than the specified time period before the start of the to-be-compensated coordinated-operation-related transmission. Second, the estimated pre-corrected value was used to compensate a coordinated-operation-related transmission less than the specified time period before the start of the to-be-compensated coordinated-operation-related transmission.

An AP device (such as the first AP device 302, the second AP device 304, or both) is not required to remember or apply pre-corrected value correction after the correction has become invalid. However, an AP device (such as the first AP device 302, the second AP device 304, or both) may continue to apply pre-corrected value correction for a longer duration as an implementation choice. The value of the time period may be preconfigured, such as at one second, or may be negotiated between the AP devices as part of CoBF setup. A suitable value for this time period may be determined based on the drift of carrier frequency of the coordinating AP devices and the useful lifetime of channel sounding information. Where the carrier frequency of the AP devices 302, 304 is very stable, such as where the drift over a time period is negligible compared to the subcarrier spacing, the determining factor may simply be the useful lifetime of sounding information for CoBF.

After an estimated inter-AP device pre-corrected value becomes invalid, the AP device 302, 304 may discard any channel sounding information related to coordinated operation. For example, channel sounding information may be deemed outdated at the expiration of the inter-AP device pre-corrected value estimate. The coordinating AP devices 302, 304 should reestablish carrier synchronization and acquire fresh channel sounding information to perform coordinated operation.

An AP device 302, 304 may also be allowed to reset the inter-AP device pre-corrected value estimate, such as by setting the estimate to zero, at the start of a new channel sounding phase. For example, the first AP device 302 transmitting a Sounding Invite frame to the second AP device 304, where the Invite frame requests the second AP device 304 to participate in cross-BSS sounding and possibly configures parameters for the upcoming cross-BSS sounding NDP, may reset the estimated inter-AP device pre-corrected value estimate. Alternatively, the first AP device 302 transmitting the first NDPA frame to the second AP device 304, meaning the NDPA frame has at least one field addressed to the second AP device 304, after a coordinated PPDU transmission involving the two AP devices, may reset the estimated inter-AP device pre-corrected value estimate. This approach is appropriate because the carrier frequency of this new phase of coordinated operation, starting with channel sounding, may not be required to be identical to the previous phase. However, if such a reset scheme is allowed, both AP devices 302, 304 should understand clearly that they should discard any old sounding at the start of the new phase of the coordinated operation, or alternatively, compensate the CSI for the carrier frequency difference between two phases.

An AP device (such as the second AP device 304) receiving certain multi-AP device-coordination-related frames from another AP device (such as the first AP device 302) as part of CoBF operation performs two functions. First, the second AP device 304 estimates residual pre-corrected value with respect to the first AP device 302. Second, if a valid pre-corrected value estimate is available, the second AP device 304 removes estimated pre-corrected value to within a required range, such as 350 Hz, from subsequent multi-AP device-coordination-related transmissions that are required to be carrier synchronized for multi-AP device-coordinated operation. For example, the multi-AP device-coordination-related frames may include CoBF Invite, CoBF Sync, CoBF Response, Ultra-High Reliability (UHR) NDPA, Beamforming Report Poll (BFRP) frames that pull a measurement report including cross-BSS sounding results from the associated stations, or other frames with inter-AP device fields.

If the magnitude of the estimated residual pre-corrected value is less than the required range, such as less than 350 Hz, the second AP device 304 satisfies the carrier synchronization requirement without applying a correction to subsequent transmissions. Multi-AP device-coordination-related transmissions that may require carrier synchronization may include UHR NDPA and NDP for joint sounding, UHR NDPA and NDP for cross-BSS sequential sounding (FIG. 4), CoBF invite frames, CoBF response frames, CoBF sync frames, and CoBF PPDUs.

An AP device (such as the first AP device 302, the second AP device 304, or both) shall deem an estimated inter-AP device pre-corrected value as valid for compensating an upcoming CoBF-related transmission under two conditions. First, the pre-corrected value was estimated from a transmission that started within the validity period before the start of the to-be-compensated CoBF-related transmission. Second, the estimated pre-corrected value was used to compensate a transmission of CoBF Invite, CoBF Sync, CoBF Response, UHR NDPA, BFRP, or other frames with inter-AP device fields within the validity period before the start of the to-be-corrected CoBF-related transmission. An AP device 302, 304 is not required to remember or apply pre-corrected value correction after the correction has become invalid. However, an AP device 302, 304 may continue to apply pre-corrected value correction for a longer duration as an implementation choice.

Although FIG. 3 illustrates an example of a joint sounding transmission diagram 300 supporting synchronization of carrier frequency of multiple access points, various changes may be made to FIG. 3. For example, various components of FIG. 3 could be combined, further subdivided, or omitted and additional components could be added according to particular needs.

FIG. 4 illustrates an example sequential sounding transmission diagram 400 supporting synchronization of carrier frequency of multiple access points according to embodiments of the present disclosure. For ease of explanation, the sequential sounding transmission diagram 400 will be described as including one or more components of the wireless network 100 of FIG. 1, such as the APs 101, 103 and the STAs 111-114; however, the sequential sounding transmission diagram 400 could be implemented using any other suitable device or system. The embodiment of the sequential sounding transmission diagram 400 shown in FIG. 4 is for illustration only. Other embodiments of the sequential sounding transmission diagram 400 could be used without departing from the scope of this disclosure. The sequential sounding transmission diagram 400 of FIG. 4 is configured similarly to the joint sounding transmission diagram 300 of FIG. 3, except as otherwise described.

As shown in FIG. 4, the sequential sounding transmission diagram 400 is configured for sequential sounding, rather than joint sounding as described in FIG. 3. For example, the first AP device 402 may transmit an announcement frame 412, a sounding frame 414, and an initial trigger frame 416 during a first sounding phase 444 before receiving a response, such as CSI frames 432 from the first non-AP STA 406. After receiving the response CSI frames 432, the first AP device 402 may then transmit the first frame 312 to the second AP device 404, where the second AP device 404 may apply a pre-correction value to the frame 322A based on the first frame 312 as described above in FIG. 3. In addition, the second AP device 404 may apply the pre-correction value to the subsequently transmitted frame 412. Similarly, the first AP device 402 and the second AP device 404 may switch roles in subsequent sounding phases, such as during a second sounding phase 446 for the second AP device 404 to transmit the announcement frame 412, sounding frame 414, and initial trigger frame 416, where the first AP device 402 applies a pre-correction value to a third frame 314, where the pre-correction value is based on a received signal of the second frame 322B received from the second AP device 404.

Although FIG. 4 illustrates an example of a sequential sounding transmission diagram 400 supporting synchronization of carrier frequency of multiple access points, various changes may be made to FIG. 4. For example, various components of FIG. 4 could be combined, further subdivided, or omitted and additional components could be added according to particular needs. In both the sounding phases 444 and 446, the in-BSS sounding is shown to occur first, followed by the cross-BSS sounding. However, the order of the in-BSS sounding and cross-BSS sounding may be reversed in either or both phases 444 and 446.

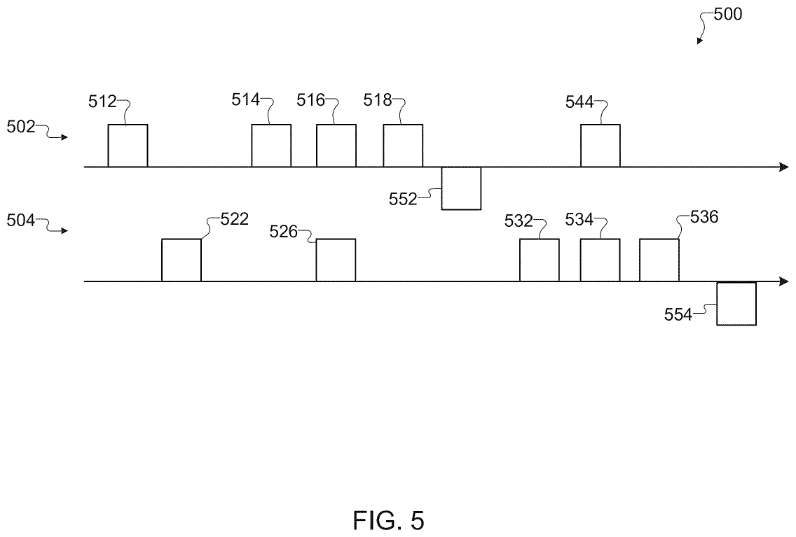

FIG. 5 illustrates an example cross-BSS sounding transmission diagram 500 supporting synchronization of carrier frequency of multiple access points according to embodiments of the present disclosure. For ease of explanation, the cross-BSS sounding transmission diagram 500 will be described as including one or more components of the wireless network 100 of FIG. 1, such as the APs 101, 103 and the STAs 111-114; however, the cross-BSS sounding transmission diagram 500 could be implemented using any other suitable device or system. The embodiment of the cross-BSS sounding transmission diagram 500 shown in FIG. 5 is for illustration only. Other embodiments of the cross-BSS sounding transmission diagram 500 could be used without departing from the scope of this disclosure.

As shown in FIG. 5, the cross-BSS sounding transmission diagram 500 includes transmission between a first AP device 502 and a second AP device 504. The first AP device 502 may transmit a sounding invitation 512 to the second AP device 504, which may provide a sounding response 522. The first AP device 502 may then transmit a first announcement frame 514. The first AP device 502 may then transmit a first data frame 516 to the second AP device 504 followed by a first trigger frame 518. The first AP device 502 may then transmit a first CSI frame 552. Upon receipt of the first CSI frame 552, the second AP device 504 may then transmit a second announcement frame 532, followed by a third data frame 534, and a second trigger frame 536 to the first AP device 502. The second AP device 504 may then transmit a second CSI frame 554.

FIG. 5 describes additional techniques for synchronizing the carriers of multiple AP, such as implicitly or explicitly designating one AP as a sync-reference while having a second AP device 504 follow procedures to keep the carrier frequency of the second AP device 504 sufficiently synchronized to the sync-reference AP. The second AP device 504 may be referred to as the sync-follower AP. Under this arrangement, the sync-reference AP does not bear any burden or make any adjustments to maintain carrier frequency synchronization between the two APs. The procedure applied by the sync-follower AP must therefore be sufficient to achieve and maintain carrier synchronization, as elaborated further below.

The AP sending the sounding invitation 512 may be implicitly designated as the sync-reference AP, and the second AP device 504 would then be implicitly designated as the sync-follower AP. Upon receiving the sounding invitation 512, the sync-follower AP (second AP device 504) may estimate a pre-corrected value (such as a CFO) with respect to the sync-reference AP (first AP device 502). If the second AP device 504 accepts the invite and indicates acceptance in a subsequent sounding response 522, the second AP device 504 is required to remove the pre-corrected value to align the carrier frequency to within the required range of the first AP device 502 for at least the subsequent NDP transmissions of the cross-BSS sounding sequence. In addition, the second AP device 504 may also be required to align the carrier frequency for NDPA transmission, BFRP transmission, or the sounding response 522 transmission. Aligning for the NDPA and NDP transmissions is preferred because otherwise the carrier frequency may jump as much as 40 ppm between NDPA transmission and NDP transmission, causing malfunction at some receiving STAs. Aligning at other frames such as the sounding response 522 or BFRP provides an opportunity for the sync-reference AP to verify that the sync-follower has achieved and is able to maintain carrier synchronization. If the second AP device 504 rejects the sounding invitation 512, the second AP device 504 is not required to align the carrier frequency, though optional alignment remains permissible.

Similarly, designation of the sync-reference AP may also occur by identifying the AP that sends the first UHR NDPA after the Invite-Response frame exchange as the sync-reference AP. The AP receiving the NDPA (for example, with an info field of the NDPA addressed to the receiving AP AID) would then be designated as the sync-follower AP.

A drawback of, for example, implicitly treating the first AP device 502 or the AP that sends the first NDPA of the cross-BSS sounding sequence as the sync-reference and the second AP device 504 as the sync-follower, is that the sync-reference AP may change from one sounding to the next, and with that change, the reference frequency may also change. For example, if the previously second AP device 504 becomes the first AP device 502 in the next round and transmits an Invite frame without keeping alignment with the previous sounding round, sounding results from the two different sounding rounds may have been acquired with different reference frequencies. Combining such results may cause degraded performance.

Although FIG. 5 illustrates an example of a cross-BSS sounding transmission diagram 500 supporting synchronization of carrier frequency of multiple access points, various changes may be made to FIG. 5. For example, various components of FIG. 5 could be combined, further subdivided, or omitted and additional components could be added according to particular needs.

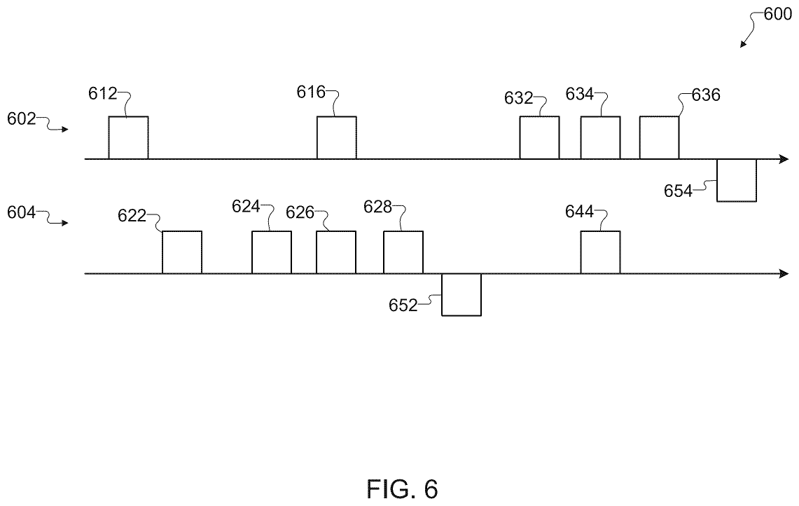

FIG. 6 illustrates an example cross-BSS sounding transmission diagram 600 supporting synchronization of carrier frequency of multiple access points according to embodiments of the present disclosure. For ease of explanation, the cross-BSS sounding transmission diagram 600 will be described as including one or more components of the wireless network 100 of FIG. 1, such as the APs 101, 103 and the STAs 111-114; however, the cross-BSS sounding transmission diagram 600 could be implemented using any other suitable device or system. The embodiment of the cross-BSS sounding transmission diagram 600 shown in FIG. 6 is for illustration only. Other embodiments of the cross-BSS sounding transmission diagram 600 could be used without departing from the scope of this disclosure.

As shown in FIG. 6, the cross-BSS sounding transmission diagram 600 includes transmission between a first AP device 602 and a second AP device 604. The first AP device 602 may transmit a sounding invitation 612 to the second AP device 604, which may provide a sounding response 622. The second AP device 604 may then transmit an announcement frame 624. The second AP device 604 may then transmit a first data frame 626 to the first AP device 602 followed by a first trigger frame 628. The second AP device 604 may then transmit a first CSI frame 652. Upon receipt of the first CSI frame 652, the first AP device 602 may then transmit a second announcement frame 632, followed by a third data frame 634, and a second trigger frame 636 to the second AP device 604. The first AP device 602 may then transmit a second CSI frame 654.

One alternative approach to the cross-BSS sounding transmission diagram 500 of FIG. 5 involves explicitly designating one AP device as the sync-reference and the other as the sync-follower, for example, during coordinated operation negotiation and setup. These designations as reference and follower may then remain fixed for the long term or across multiple rounds of sounding and coordinated data transmissions.

When the designated sync-reference AP device sends the sounding invitation 612 frame, the sync-follower AP device may use the sounding invitation 612 frame to align the carrier for subsequent multi-AP device-coordination-related transmissions that are required to be carrier synchronized, as previously mentioned. Alternatively, if only NDPA is used for carrier synchronization and the sync-reference AP device is the first AP device sending the NDPA, the sync-follower AP device can synchronize the carrier to the reference and transmit subsequent cross-BSS NDPs and any other frames that are required to be carrier synchronized with the sync-reference using an aligned carrier frequency.

However, when the sync-follower AP device sends the sounding invitation 612 or sends the first NDPA, the carrier frequency of the sync-follower AP device may have drifted, in particular outside the required range of 350 Hz, with respect to the sync-reference, for example, due to the time elapsed since the last time the sync-follower AP device was able to receive a reference transmission from the sync-reference AP device. To address this issue, when the sync-follower AP device is the one sending the sounding invitation 612, the sync-follower AP device uses the sounding response 622 transmitted by the sync-reference AP device to align the carrier frequency of the sync-follower AP device to the sync-reference. If the sounding response 622 indicates acceptance of the invite, the Inviting AP device, being the sync-follower, subsequently transmits one or more NDPs with the aligned carrier frequency. As mentioned earlier, the follower AP device may also be required to align other frames besides NDPs, such as NDPA and BFRP frames.

An alternative solution provides that the first NDPA after the sounding invitation 612—Response frame exchange is sent by the sync-reference AP device. For example, when the sync-follower AP device is the one sending the sounding invitation 612, the first NDPA is sent by the Responding AP device, as shown in FIG. 4. The sync-follower AP device, being the Inviting AP device, then uses the NDPA frame transmitted by the sync-reference AP device to align the carrier frequency of the sync-follower AP device to the sync-reference. The Inviting AP device, being the sync-follower, subsequently transmits one or more NDPs with the aligned carrier frequency. As mentioned earlier, the follower AP device may also be required to align other frames besides NDPs, such as NDPA and BFRP frames.

Although FIG. 6 illustrates an example of a cross-BSS sounding transmission diagram 600 supporting synchronization of carrier frequency of multiple access points, various changes may be made to FIG. 6. For example, various components of FIG. 6 could be combined, further subdivided, or omitted and additional components could be added according to particular needs.

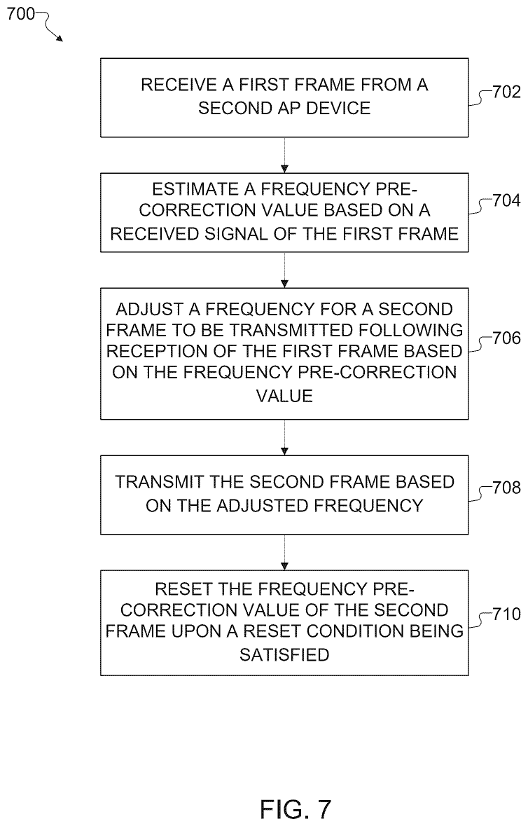

FIG. 7 illustrates an example flow chart of a method 700 for synchronizing carrier frequency of multiple access points according to embodiments of the present disclosure. An embodiment of the method illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments for synchronizing carrier frequency of multiple access points could be used without departing from the scope of this disclosure.

As shown in FIG. 7, a first frame is received from a second AP device at step 702. For example, the second AP device 304 may receive the first frame 312 from the first AP device 302 during, for example, a first sounding phase 344 or a first coordinated data transmission phase 354.

A frequency pre-correction value is estimated based on a received signal of the first frame at step 704. For example, the second AP device 304 may estimate a pre-correction value using a frequency of the first frame 312. For example, the first frame may include a cross-BSS NDPA received during the sounding phase, and the second frame includes an extremely high throughput (EHT) null data packet (NDP) and is transmitted immediately following the cross-BSS NDPA. In such conditions, adjusting the frequency for the second frame may include correcting the frequency to bring the frequency within 350 Hz of a frequency of the first frame including the cross-BSS NDPA. Additionally or alternatively, the first frame may be a sync frame received during a coordinated data transmission phase, and the second frame is a CoBF data frame and is transmitted immediately following the sync frame. As such, adjusting the frequency for the CoBF frame may include correcting the frequency to bring the frequency within 350 Hz of a frequency of the sync frame.

A frequency is adjusted for a second frame to be transmitted following reception of the first frame based on the frequency pre-correction value at step 706. For example, the second AP device 304 may apply the pre-correction value to a frequency of the second frame 322A before transmission of the second frame 322A. The second frame is transmitted based on the adjusted frequency at step 708.

The frequency pre-correction value of the second frame is reset upon a reset condition being satisfied at step 710. For example, the second AP device 304 may reset the pre-correction value based upon a predetermined reset condition. For example, the reset condition may include expiration of a validity duration or initiation of a subsequent channel sounding phase (such as the second sounding phase 344).

Although FIG. 7 illustrates an example flow chart of a method 700 for synchronizing carrier frequency of multiple access points, various changes may be made to FIG. 7. For example, while shown as a series of steps, various steps in FIG. 7 could overlap, occur in parallel, occur in a different order, or occur any number of times.

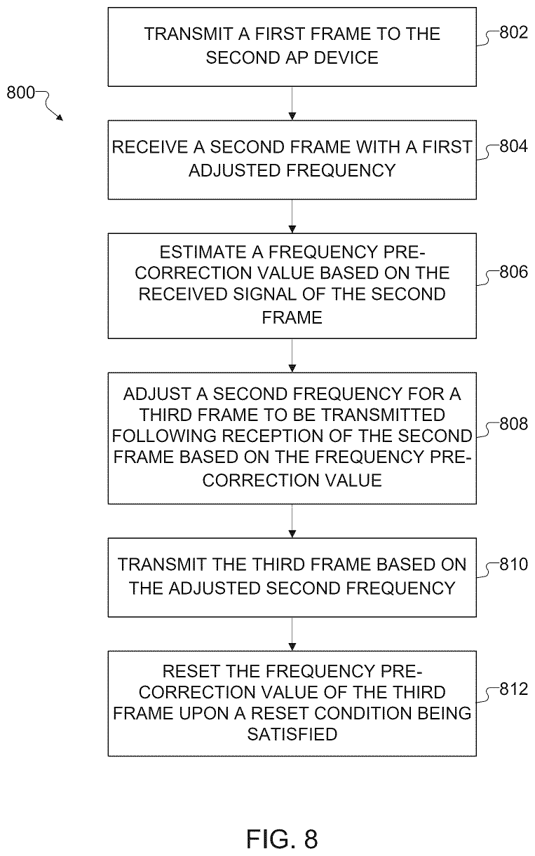

FIG. 8 illustrates an example flow chart of a method 800 for synchronizing carrier frequency of multiple access points according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of for synchronizing carrier frequency of multiple access points could be used without departing from the scope of this disclosure.

As shown in FIG. 8, a first frame is transmitted to the second AP device at step 802. For example, the first AP device 302 may transmit the first frame 312 to the second AP device 304.

A second frame is received with a first adjusted frequency at step 804. For example, the first AP device 302 may receive the second frame 322B from the second AP device 304. The second frame 322B may include a frequency that is adjusted based on an estimated pre-correction value determined by the second AP device 304.

A frequency pre-correction value is estimated based on the received signal of the second frame at step 806. For example, the first AP device 302 may estimate a second pre-correction value based on the received second frame 322B.

A second frequency for a third frame to be transmitted following reception of the second frame is adjusted based on the frequency pre-correction value at step 808. For example, the first AP device 302 may apply the second pre-correction value to a frequency of the third frame 316 generated by the first AP device 302. The second frame includes a cross-basic service set (BSS) null data packet announcement (NDPA) received during a sounding phase; and the third frame includes an extremely high throughput (EHT) null data packet (NDP) and is transmitted immediately following the cross-BSS NDPA. In such conditions, adjusting the frequency for the third frame may include correcting the frequency to bring the frequency within 350 Hz of a frequency of the second frame including the cross-BSS NDPA. Additionally or alternatively, the second frame is a sync frame received during a coordinated data transmission phase, and the third frame is a coordinated beamforming (CoBF) data frame and is transmitted immediately following the sync frame. As such, adjusting the frequency for the CoBF frame may include correcting the frequency to bring the frequency within 350 Hz of a frequency of the sync frame. The third frame is transmitted based on the adjusted second frequency at step 810.

The frequency pre-correction value is reset of the third frame upon a reset condition being satisfied at step 812. For example, the first AP device 302 may reset the pre-correction value based upon a predetermined reset condition. For example, the reset condition may include expiration of a validity duration or initiation of a subsequent channel sounding phase (such as the second sounding phase 344).

Although FIG. 8 illustrates an example flow chart of a method 800 for synchronizing carrier frequency of multiple access points, various changes may be made to FIG. 8. For example, while shown as a series of steps, various steps in FIG. 8 could overlap, occur in parallel, occur in a different order, or occur any number of times.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a first access point (AP) device, the method comprising:
receiving a first frame from a second AP device;
estimating a frequency pre-correction value based on a received signal of the first frame;
adjusting a frequency for a second frame to be transmitted following reception of the first frame based on the frequency pre-correction value; and
transmitting the second frame based on the adjusted frequency.

2. The method of claim 1, wherein:
the first frame includes a cross-basic service set (BSS) null data packet announcement (NDPA) received during a sounding phase; and
the second frame includes an extremely high throughput (EHT) null data packet (NDP) and is transmitted immediately following the cross-BSS NDPA.

3. The method of claim 2, wherein adjusting the frequency for the second frame comprises correcting the frequency to bring the frequency within 350 Hz of a frequency of the first frame including the cross-BSS NDPA.

4. The method of claim 1, wherein:
the first frame is a sync frame received during a coordinated data transmission phase; and
the second frame is a coordinated beamforming (CoBF) data frame and is transmitted immediately following the sync frame.

5. The method of claim 4, wherein adjusting the frequency for the CoBF frame comprises correcting the frequency to bring the frequency within 350 Hz of a frequency of the sync frame.

6. The method of claim 1, further comprising resetting the frequency pre-correction value of the second frame upon a reset condition being satisfied.

7. The method of claim 6, wherein the reset condition includes expiration of a validity duration or initiation of a subsequent channel sounding phase.

8. The method of claim 1, wherein:
the first frame includes at least one of a cross-BSS NDPA, a CoBF invite frame, a CoBF response frame, and a CoBF sync frame received during a CoBF session;
the second frame includes at least one of a cross-BSS NDPA, a CoBF invite frame, a CoBF response frame, a CoBF sync frame, a CoBF data frame; and
the second frame is transmitted after receiving the first frame.

9. A method performed by a second access point (AP) device in response to a first AP device, the method comprising:
transmitting a first frame to the first AP device;
receiving a second frame with a first adjusted frequency;
estimating a frequency pre-correction value based on the received signal of the second frame;
adjusting a second frequency for a third frame to be transmitted following reception of the second frame based on the frequency pre-correction value; and
transmitting the third frame based on the adjusted second frequency.

10. The method of claim 9, wherein:
the second frame includes a cross-basic service set (BSS) null data packet announcement (NDPA) received during a sounding phase; and
the third frame includes an extremely high throughput (EHT) null data packet (NDP) and is transmitted immediately following the cross-BSS NDPA.

11. The method of claim 10, wherein adjusting the frequency for the third frame comprises correcting the frequency to bring the frequency within 350 Hz of a frequency of the second frame including the cross-BSS NDPA.

12. The method of claim 9, wherein:
the second frame is a sync frame received during a coordinated data transmission phase; and
the third frame is a coordinated beamforming (CoBF) data frame and is transmitted immediately following the sync frame.

13. The method of claim 12, wherein adjusting the frequency for the CoBF frame comprises correcting the frequency to bring the frequency within 350 Hz of a frequency of the sync frame.

14. The method of claim 9, further comprising resetting the frequency pre-correction value of the third frame upon a reset condition being satisfied.

15. The method of claim 14, wherein the reset condition includes expiration of a validity duration or initiation of a subsequent channel sounding phase.

16. The method of claim 9, wherein:
the second frame includes at least one of a cross-BSS NDPA, a CoBF invite frame, a CoBF response frame, and a CoBF sync frame received during a CoBF session;
the third frame includes at least one of a cross-BSS NDPA, a CoBF invite frame, a CoBF response frame, a CoBF sync frame, a CoBF data frame; and
the third frame is transmitted after receiving the second frame.

17. An electronic device comprising:
at least one processor including processing circuitry; and
a memory storing instructions, wherein the instructions, when executed by the at least one processor individually or collectively, cause the electronic device to:
receive a first frame from a second AP device;
estimate a frequency pre-correction value based on the received signal of the first frame;
adjust a frequency for a second frame to be transmitted following reception of the first frame based on the frequency pre-correction value; and
transmit the second frame based on the adjusted frequency.

18. The electronic device of claim 17, wherein:
the first frame includes a cross-basic service set (BSS) null data packet announcement (NDPA) received during a sounding phase; and
the second frame includes an extremely high throughput (EHT) null data packet (NDP) and is transmitted immediately following the cross-BSS NDPA.

19. The electronic device of claim 18, wherein adjusting the frequency for the second frame comprises correcting the frequency to bring the frequency within 350 Hz of a frequency of the first frame including the cross-BSS NDPA.

20. The electronic device of claim 17, wherein:
the first frame is a sync frame received during a coordinated data transmission phase;
the second frame is a coordinated beamforming (CoBF) data frame and is transmitted immediately following the sync frame; and
adjusting the frequency for the CoBF frame comprises correcting the frequency to bring the frequency within 350 Hz of a frequency of the sync frame.
